(19) United States
(12) Patent Application Publication
(10) Pub. No.: US 2003/0016921 A1
(43) Pub. Date: Jan. 23, 2003

(54) Video reproducing/recording system to change a logo image/sound, and method of changing the logo image/sound

(76) Inventor: Seung-kyu Paek, Gyeonggi-do (KR)

Correspondence Address: STAAS & HALSEY LLP, 700 11TH STREET, NW, SUITE 500, WASHINGTON, DC, 20001, US

(21) Appl. No.: 10/043,273

(22) Filed: Jan. 14, 2002

(30) Foreign Application Priority Data
Jul. 23, 2001 (KR) 2001-44200

(51) Int. Cl. H04N 5/781; G02B 6/255

(52) U.S. Cl. 385/95; 386/125

(57) ABSTRACT

A video reproducing/recording system capable of changing a logo image/sound and a method therefor. The method includes selecting a data source path through which the logo image/sound is selected in a mode of changing the logo image/sound, storing video and/or audio data received through the selected data source path, selecting the stored video and/or audio data, designating the selected video and/or audio data as the logo image/sound, and outputting the designated logo video and/or audio data whenever the video reproducing/recording system is stopped. In the video reproducing/recording system, a user can change the logo image/sound to be an image or sound he or she desires, for example, a family photo or a scenery photo, through various interfaces.

### CROSS-REFERENCE TO RELATED APPLICATIONS

This application claims the benefit of Korean Application No. 2001-44200, filed Jul. 23, 2001, in the Korean Industrial Property Office, the disclosure of which is incorporated herein by reference.

### BACKGROUND OF THE INVENTION

1. Field of the Invention

The present invention relates to a video reproducing/recording system, and more particularly, to a video reproducing/recording system capable of changing a logo image/sound and a method of changing the logo image/sound.

2. Description of the Related Art

Generally, a video reproducing/recording system, such as an optical disc player, displays a logo image on a monitor when power is turned on.

FIG. 1 is a block diagram of an optical disc player that outputs a general logo image. Referring to FIG. 1, a pickup 120 reads data stored in a disc 110 and outputs the same as an EFM (eight to fourteen) signal. A digital signal processor (DSP) 130 demodulates the EFM signal read from the pickup 120 into audio/video (AV) data. A servo unit 140 receives information needed to control a servo (not shown) and controls the position of the pickup 120. A decoder 170 decodes the A/V data generated by the DSP 130 to generate an AV signal. A memory 160 includes video data to be displayed as a logo image when the optical disc player stops. A system controller 150 controls the pickup 120, the DSP 130, the servo unit 140, the decoder 170 and the memory 160 in response to a key command input by a user.

The system controller 150 further allows the video data stored in the memory 160 to be output as the logo image to a monitor (not shown) whenever power is turned on or the optical disc player is stopped.

However, in a conventional optical disc player, it is not possible to change the logo image because it is not possible to erase data related to the logo image stored in the memory 160, which may be a read only memory (ROM), during manufacturing of the optical disc player.

### SUMMARY OF THE INVENTION

Accordingly, it is an object of the present invention to provide a method of changing a logo image and/or sound into another logo image and/or sound through a variety of interfaces.

It is another object of the present invention to provide a video reproducing/recording system allowing a user to change a logo image and/or sound into another logo image and/or sound through various interfaces.

Additional objects and advantages of the invention will be set forth in part in the description which follows and, in part, will be obvious from the description, or may be learned by practice of the invention.

The foregoing and other objects of the present invention are achieved by providing a method of changing a logo image and/or sound in a video reproducing/recording system. In the method, a data source path through which the logo image and/or sound is received is selected in a mode of changing the logo image and/or sound. Next, video and/or audio data received through the selected data source path is stored and then, the stored video and/or audio data is selected. The selected video and/or audio data is designated as the logo image and/or sound. Thereafter, the designated logo video and/or audio data is output whenever the video reproducing/recording system is stopped.

The foregoing and other objects of the present invention are also achieved by providing a video reproducing/recording system capable of reproducing and recording an audio/video (AV) signal received from a predetermined recording medium. The system includes a decoder to demodulate audio/video data read from the predetermined recording medium, an interface unit to receive video and/or audio data through a wire or wireless interface, a memory to store the video and/or audio data input to the interface unit or the decoder, and a controller to store or delete logo video and/or audio data in or from the memory in response to a command to change/delete a logo image and/or sound, and to designate the stored logo video and audio data as the logo image and/or sound.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a block diagram of a conventional optical disc player for outputting a general logo image;

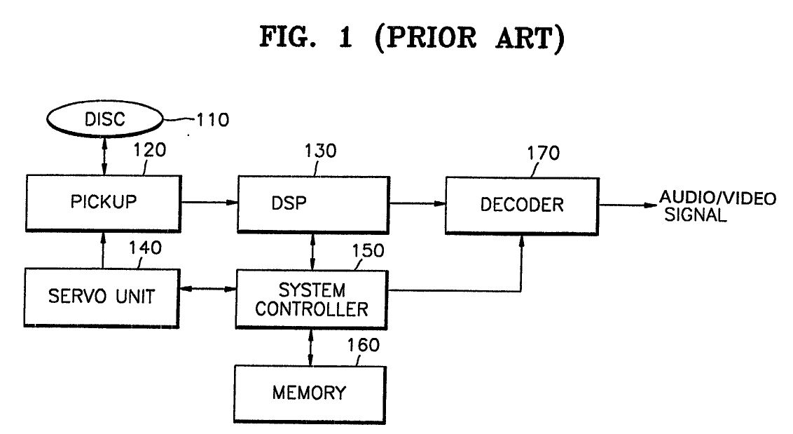

FIG. 2 is a block diagram of a video reproducing/recording system to change a logo image and/or sound according to the present invention; and

FIG. 3 is a flowchart for explaining a method of changing a logo image/sound through a video reproducing/recording system according to the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

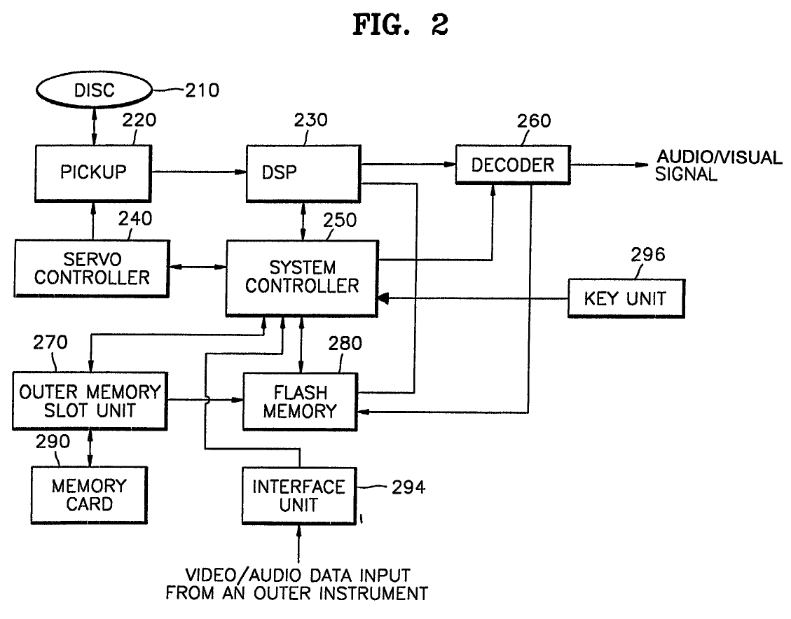

FIG. 2 shows a video reproducing/recording system capable of changing a logo image and/or sound according to the present invention. Referring to FIG. 2, a pickup 220 reads data recorded in a disc 210 and outputs the same as an EFM signal, and further, generates a servo signal using the EFM signal. A digital signal processor (DSP) 230 demodulates the EFM signal output from the pickup 220 into an original symbol data. A servo controller 240 controls a position of the pickup 220 using the servo signal.

An interface unit 294 receives logo audio/video (AV) data from an external source such as the Internet through a wire or wireless interface such as a universal serial bus (USB), an IEEE1394 interface, a Bluetooth interface, or an RS-232C interface. An outer memory slot unit 270 is a connector to which a memory card 290 is connected. The memory card 290 is attachable to and detachable from the outer memory slot unit 270, in which logo AV data is stored.

A flash memory 280 is rewritable and contains logo AV data in its sectional regions. Any logo AV data received via recording media, such as the memory card 290, the interface unit 294, a decoder 260 or an external optical disc player (not shown), is also stored in the flash memory 280. The decoder 260 decodes data demodulated by the DSP 230 into AV data which is adapted to a television format.

A key unit 296 is located on a remote controller or touch panel, which can additionally include a function key to change a logo image/audio or delete the present logo image/audio. Also, the key unit 296 delivers a command to change a logo image/audio or delete the present logo image/audio selected by a user to a system controller 250.

The system controller 250 controls the pickup 220, the DSP 230, the decoder 260, the outer memory slot unit 270 and the flash memory 280 in response to the command input by the user in the key unit 296. Also, the system controller 250 outputs logo AV data stored in the flash memory 280 to be displayed as a logo image and/or sound in a monitor or speaker (not shown) whenever power is turned on or the optical disc player is stopped. In the system controller 250, in response to a command to change the logo image/sound or delete the present logo image/sound, which is output from the key unit 296, logo AV data received by any one of the memory card 290, the interface unit 294 or the decoder 260 is stored in or deleted from the flash memory 280. Furthermore, the system controller 250 selects the stored logo AV data and outputs it in the monitor or speaker through the decoder 260 at a stopping point, i.e., when power is turned on or the optical disc player is stopped.

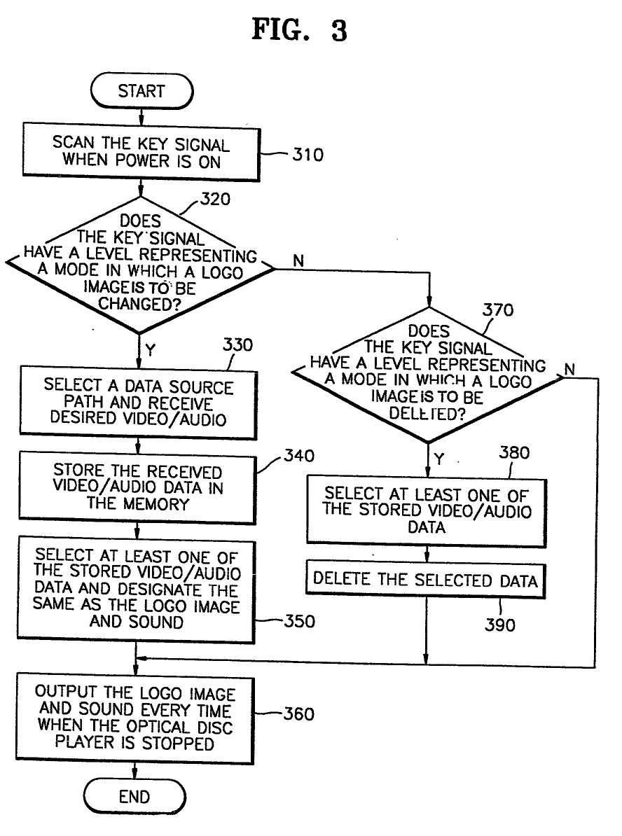

FIG. 3 is a flowchart of a method of changing a logo image/sound in a video reproducing/recording system according to the present invention. Referring to FIG. 3, when power is on, a key signal input from a key unit placed on a remote controller or touch panel is scanned (s310).

Then, it is checked whether the key signal has a level representing a mode in which a logo image/sound is to be changed (s320).

Thereafter, when the key signal has a level representing a mode in which the logo image/sound is to be changed, one of the data source paths related to the logo image/sound, e.g., the memory card 290, the decoder 260 or an outside network, is selected and AV data which is requested by a user is received (s330).

Next, the received AV data is stored in the flash memory 280 (s340).

Then, the logo AV data stored in the flash memory 280 is chosen and designated as a logo image and/or sound (s350).

In the meantime, after performing step 320, in the case that the key signal has a level representing a mode in which the logo image/sound is to be deleted (s370), AV data stored in the flash memory 280 is selected (s380) and deleted (s390).

Then, designated logo AV data is output to a monitor or speaker at a point of starting the operation of the video reproducing/recording system or stopping an optical disc player (s360).

Although a few preferred embodiments of the present invention have been shown and described, it will be appreciated by those skilled in the art that changes may be made in these embodiments without departing from the principles and spirit of the invention, the scope of which is defined in the claims and their equivalents. For example, the method of changing the logo image/sound according to the present invention may also be used by a video tape recorder, a CD player, a DVD player, a CD-RAM or a CD-RW.

As described above, the video reproducing/recording system according to the present invention allows a user to change a logo image and/or sound to be an image or sound he or she desires through various interfaces. For instance, a family photo, a scenery photo or the like can be used as the logo image.

What is claimed is:

1. A method of changing a logo image and/or sound in a video reproducing/recording system, the method comprising:
selecting a data source path through which the logo image and/or sound is received in a mode of changing the logo image and/or sound;
storing video and/or audio data received through the selected data source path selecting the stored video and/or audio data;
designating the selected video and/or audio data as the logo image and/or sound; and
outputting the designated logo video and/or audio data whenever the video reproducing/recording system is stopped.

2. The method of claim 1, further comprising:
checking an operational mode of the video reproducing/recording system; and
selecting and deleting the stored video and/or audio data in a mode of deleting the logo image and/or sound.

3. The method of claim 1, wherein the data source is one of external network data, data stored in a memory card, decoded data and data read from a recording medium.

4. A video reproducing/recording system in which a video/audio signal is reproduced from and recorded on a recording medium, the system comprising:
a key unit to select a mode of changing a logo image/sound or a mode of deleting the logo image/sound, and a data source path through which the logo image and/or sound is received;
a source unit to provide the logo image/sound according to the data source path selected by the key unit;
a memory to store the logo image/sound provided by the source unit; and
a controller to select the data source path, to store logo video and/or audio data comprising the logo image/sound in the memory, to store or delete the logo video and/or audio data the memory in response to a command to change/delete the logo image/sound, and to designate the stored logo video and/or audio data as the logo image/sound.

5. The system of claim 4, comprising:
a decoder to demodulate audio/video data read from the recording medium; and
an interface unit to receive the logo video and/or audio data through a wire or wireless interface.

6. The system of claim 4, wherein the memory is a rewriteable flash memory.

7. The system of claim 4, further comprising a memory card attachable to and detachable from the video reproducing/recording system in which the logo video and/or audio data is stored.

8. The system of claim 4, wherein the reproduced video/audio signal is read from an optical disc.

9. The system of claim 5, wherein the interface unit receives the logo video and/or audio data from the Internet.

10. The system of claim 4, wherein the controller outputs the logo video and/or audio data whenever the video reproducing/recording system is stopped or power of the video reproducing/recording system is turned on.

11. The system of claim 4, wherein the reproduced video/audio signal is read from a video tape.

12. The system of claim 8, wherein the optical disc is a CD, DVD, CD-RAM or CD-RW.

13. A reproducing/recording system to reproduce/record data to/from a recording medium, comprising:
a memory to store a logo image/sound; and
a source unit to provide the logo image/sound to the memory,
the memory being rewriteable to change the logo image/sound based on a request from a user.

14. The system of claim 13, further comprising a key unit to input the request from the user to the source unit and thereby select a source of the logo image/sound.

15. The system of claim 14, wherein the source of the logo image/sound is a memory card, an optical disc, the Internet, or the recording medium.

16. The system of claim 15, further comprising:
a controller to select audio/visual data from the source of the logo image/sound, store the selected audio/visual data in the memory as the logo image/sound, and delete a previous logo image/sound from the memory.

17. The system of claim 15, further comprising:
a controller to delete a previous logo image/sound from the memory.

18. The system of claim 17, wherein the controller outputs the audio/visual data whenever the reproducing/recording system is stopped or power of the reproducing/recording system is turned on.

19. A method of handling logo image/sound data in a memory of a reproducing/recording system, comprising:
receiving an instruction to delete the logo image/sound data from the memory;
selecting the logo image/sound data in the memory to be deleted; and
deleting the logo image/sound data from the memory.
